(19) United States
(12) Patent Application Publication
(10) Pub. No.: US 2018/0211250 A1
(43) Pub. Date: Jul. 26, 2018

(54) SYSTEM FOR TRANSFER OF RESOURCES VIA A SECURE CHANNEL USING AN ALIAS

(71) Applicant: BANK OF AMERICA CORPORATION, Charlotte, NC (US)

(72) Inventors: Tony England, Tega Cay, SC (US); Michael K. Lee, San Mateo, CA (US); Andrew DongHo Kim, Glendale, AZ (US); Craig D. Widmann, Chandler, AZ (US)

(21) Appl. No.: 15/415,296

(22) Filed: Jan. 25, 2017

(51) Int. Cl. G06Q 20/38; H04L 29/08; H04L 29/06; G06Q 20/40

(52) U.S. Cl. CPC G06Q 20/385; H04L 67/20; G06Q 20/40; H04L 63/10; H04L 67/02

(57) ABSTRACT

Systems, computer program products, and methods are described herein for transfer of resources via a secure channel using an alias. The present invention receives a first alias associated with a user; dynamically generates a web portal associated with the entity to enable the user to input an authorization code; electronically receives, via the web portal, the authorization code from the user; determine a first resource event based on at least receiving the first alias and the authorization code; triggers the first resource event based on at least a successful validation of the authorization code; and transfers the resources from the user record associated with the third party to the target record via the secure channel in response to triggering the first resource event.

### BACKGROUND

As consumers make purchases increasingly online and via electronic channels, their payment expectations are changing. The growing acceptance of electronic person-to-person (P2P) consumer payments is paving the way for entities to adopt new electronic payment methods. There is a need for a system to leverage proven person-to-person (P2P) technology and integrate its existing infrastructure with other network services, thereby facilitating the transfer of resources via secure channels. Accordingly, the present invention provides the consumer with resource transfer options that provide convenience, choice, control, and secure transfer options.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for transfer of resources via a secure channel using an alias is presented. The system comprises at least one non-transitory storage device; at least one processor; and at least one module stored in said storage device and comprising instruction code that is executable by the at least one processor and configured to cause said at least one processor to: electronically receive, via a user interface associated with a third party, a first alias associated with a user, wherein the first alias is associated with an entity; dynamically generate on the user interface associated with the third party, a web portal associated with the entity, wherein the web portal comprises a control element to enable the user to input an authorization code; electronically receive, via the web portal, the authorization code from the user; determine a first resource event based on at least receiving the first alias and the authorization code, wherein the first resource event comprises a transfer of resources, via a secure channel associated with the entity, from a user record associated with the third party to a target record; trigger the first resource event based on at least a successful validation of the authorization code; and transfer the resources from the user record associated with the third party to the target record via the secure channel in response to triggering the first resource event.

In some embodiments, the module is further configured to: electronically receive, via the user interface associated with the third party, a second alias associated with the user, wherein the second alias comprises identification information associated with one or more user liability records; determine a second resource event based on at least receiving the second alias, wherein the second resource event comprises a transfer of resources, via the secure channel, from the user record associated with the third party to the one or more liability records; trigger the second resource event; and transfer resources from the user record associated with the third party to the one or more liability records via the secure channel in response to triggering the second resource event.

In some embodiments, the module is further configured to: retrieve one or more resource events associated with the user; dynamically generate at least one authorization code for each of the one or more resource events; map the at least one authorization code to the one or more resource events; and communicate the at least one authorization code to the user.

In some embodiments, the at least one authorization code is communicated to the user via at least an online portal, a contact center, a financial center, a text message, and an email.

In some embodiments, the module is further configured to: retrieve one or more resource events associated with the user; initiate a presentation of the one or more resource events for display on a user computing device; receive a user selection of at least one of the one or more resource events; receive a user input comprising at least one authorization code for each of the one or more resource events selected by the user; map the at least one authorization code with each of the one or more resource events selected by the user; and communicate the at least one authorization code to the user.

In some embodiments, the module is further configured to trigger the resource event, wherein triggering further comprises: identifying the target record; establishing the secure channel between the user record associated with the third party and the target record; and initiating, via the secure channel, the transfer of resources between the user record associated with the third party and the target record.

In some embodiments, the third party is an alias-based payment service.

In some embodiments, the module is further configured to determine the target record from a plurality of target records based on at least the authorization code.

In another aspect, a computerized method for transfer of resources via a secure channel using an alias is presented. The method comprising: electronically receiving, via a user interface associated with a third party, a first alias associated with a user, wherein the first alias is associated with an entity; dynamically generating, using a computing device processor, on the user interface associated with the third party, a web portal associated with the entity, wherein the web portal comprises a control element to enable the user to input an authorization code; electronically receiving, via the web portal, the authorization code from the user; determining, using a computing device processor, a first resource event based on at least receiving the first alias and the authorization code, wherein the first resource event comprises a transfer of resources, via a secure channel associated with the entity, from a user record associated with the third party to a target record; triggering, using a computing device processor, the first resource event based on at least a successful validation of the authorization code; and transferring, using a computing device processor, the resources from the user record associated with the third party to the target record via the secure channel in response to triggering the first resource event.

In yet another aspect, a computer program product for transfer of resources via a secure channel using an alias is presented. The computer program product comprising a non-transitory computer-readable medium comprising code causing a first apparatus to: electronically receive, via a user interface associated with a third party, a first alias associated with a user, wherein the first alias is associated with an entity; dynamically generate on the user interface associated with the third party, a web portal associated with the entity, wherein the web portal comprises a control element to enable the user to input an authorization code; electronically receive, via the web portal, the authorization code from the user; determine a first resource event based on at least receiving the first alias and the authorization code, wherein the first resource event comprises a transfer of resources, via a secure channel associated with the entity, from a user record associated with the third party to a target record; trigger the first resource event based on at least a successful validation of the authorization code; and transfer the resources from the user record associated with the third party to the target record via the secure channel in response to triggering the first resource event.

### BRIEF DESCRIPTION OF THE DRAWINGS

Having thus described embodiments of the invention in general terms, reference will now be made to the accompanying drawings, where:

FIG. 1 illustrates technical components of a system for transfer of resources via a secure channel using an alias, in accordance with an embodiment of the invention;

FIG. 2 illustrates a general process flow for transfer of resources via a secure channel using a first alias and an authorization code, in accordance with an embodiment of the invention;

FIG. 3 illustrates a general process flow for transfer of resources via a secure channel using a second alias, in accordance with an embodiment of the invention;

FIG. 4 illustrates a general process flow for mapping a dynamically generated authorization code to a resource events, in accordance with an embodiment of the invention; and

FIG. 5 illustrates a general process flow for mapping a user generated authorization code to a resource events, in accordance with an embodiment of the invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Embodiments of the invention are directed to systems, methods and computer program products for transfer of resources via a secure channel using an alias. With mobile devices so prevalent, there is a strong consumer preference to make, receive, and monitor payments via a mobile device. These payments provide consumers with more control than check cards and cash payments. The present invention enables the integration of third party P2P services with an existing financial institution network service platform to enable users to access one or more features associated with the financial institution, who may otherwise not have access to them. In this way, the present invention enables users to utilize third party P2P services of their choosing to execute payments instantly, thereby avoiding additional processing time. Further, by using aliases in lieu of account information, users may remain anonymous and protect account information from being stored in multiple locations.

Accordingly, the present invention enables the user to utilize a universal common alias to transfer funds by leveraging a third party P2P service and integrating the network services of the P2P service with the financial institution network services. In this regard, the present invention receives an alias and an authorization code from the user. The authorization code is used to identify a target account for the funds to be transferred into. In response to receiving the information, the system is then configured to initiate the transfer of funds from a deposit account associated with the third party P2P service to the target account. In other embodiments, the present invention enables the user to utilize specific aliases to identify target accounts associated with the user, and transfer funds from a deposit account associated with the third party P2P service to the target account.

In some embodiments, an “entity” as used herein may refer to an organization comprising multiple individuals such as an institution or an association that has a collective goal and external environment. Typically, organizations have a management structure that determines relationships between different activities and the members, and subdivides and assigns roles, responsibilities, and authority to carry out different tasks. For purposes of the invention, resources may indicate one or more hardware and/or software available to the user and enables the user to work towards the collective goal of the entity.

In some embodiments, the “user” may be an individual who operates the user input system described herein and is associated with an entity under a contract of employment, either part-time or full-time.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, a “resource” includes accounts and/or other property that may be made available to the user. In most example implementations contemplated herein, the resource is an ownership interest in a privately-held business entity that is transitioning to be a publicly-held business entity. Consequently, many example implementations envision the “resource” (either in whole or in its constituent parts, as shares of stock, including fractional shares. Notwithstanding the foregoing, the term “resource” need not be artificially limited to the context of stock and/or shares in a business entity, but rather the term “resource” can encompass a broad range of example items, including monetary assets, collections and portions thereof (such as collections of art, possessions, and/or other goods), commodities, accounts, other property, and the like.

In the context of example implementations described herein, a “transaction” or “resource distribution” refers to any transfer of resources to and/or from a user. A transaction may refer to a purchase of shares of stock, goods, or and/or other resources.

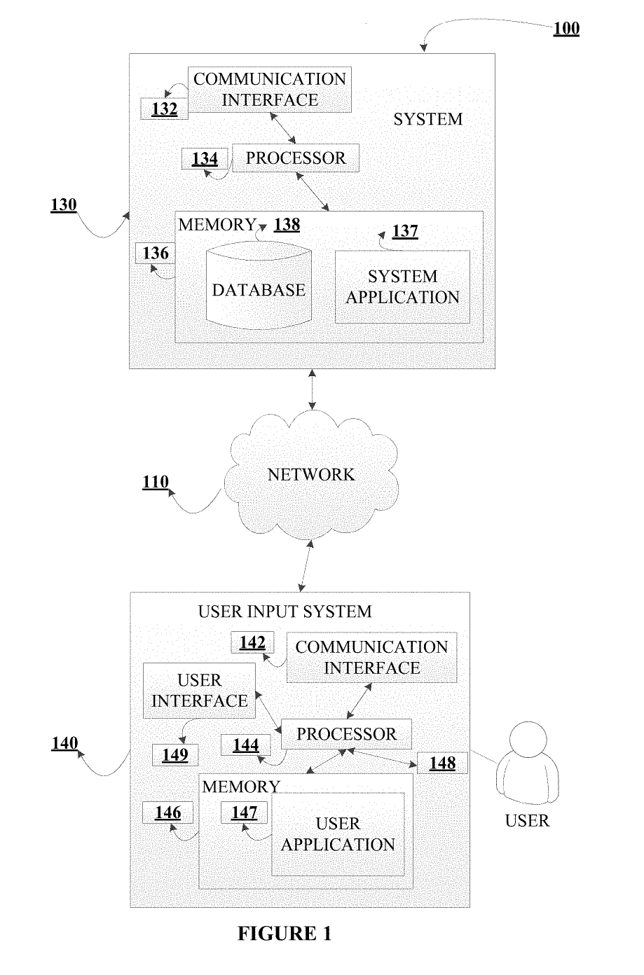

FIG. 1 presents an exemplary block diagram of the system environment 100 for implementing the process flows described herein in accordance with embodiments of the present invention. As illustrated, the system environment 100 includes a network 110, a system 130, and a user input system 140. Also shown in FIG. 1 is a user of the user input system 140. The user input system 140 may be a mobile device or other non-mobile computing device. The user may be a person who uses the user input system 140 to execute a user application 147. The user application 147 may be an application to communicate with the system 130, perform a transaction, input information onto a user interface presented on the user input system 140, or the like. The user application 147 and/or the system application 137 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

The user input system 140 may include any computerized apparatus that can be configured to perform any one or more of the functions of the user input system 140 described and/or contemplated herein. For example, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like. In some embodiments, for example, the user input system 140 may include a personal computer system (e.g. a non-mobile or non-portable computing system, or the like), a mobile computing device, a personal digital assistant, a mobile phone, a tablet computing device, a network device, and/or the like. As illustrated in FIG. 1, in accordance with some embodiments of the present invention, the user input system 140 includes a communication interface 142, a processor 144, a memory 146 having an user application 147 stored therein, and a user interface 149. In such embodiments, the communication interface 142 is operatively and selectively connected to the processor 144, which is operatively and selectively connected to the user interface 149 and the memory 146. In some embodiments, the user may use the user application 147 to execute processes described with respect to the process flows described herein. Specifically, the user application 147 executes the process flows described herein.

Each communication interface described herein, including the communication interface 142, generally includes hardware, and, in some instances, software, that enables the user input system 140, to transport, send, receive, and/or otherwise communicate information to and/or from the communication interface of one or more other systems on the network 110. For example, the communication interface 142 of the user input system 140 may include a wireless transceiver, modem, server, electrical connection, and/or other electronic device that operatively connects the user input system 140 to another system such as the system 130. The wireless transceiver may include a radio circuit to enable wireless transmission and reception of information. Additionally, the user input system 140 may include a positioning system. The positioning system (e.g. a global positioning system (GPS), a network address (IP address) positioning system, a positioning system based on the nearest cell tower location, or the like) may enable at least the user input system 140 or an external server or computing device in communication with the user input system 140 to determine the location (e.g. location coordinates) of the user input system 140.

Each processor described herein, including the processor 144, generally includes circuitry for implementing the audio, visual, and/or logic functions of the user input system 140. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 147 of the memory 146 of the user input system 140.

Each memory device described herein, including the memory 146 for storing the user application 147 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

As shown in FIG. 1, the memory 146 includes the user application 147. In some embodiments, the user application 147 includes an interface for communicating with, navigating, controlling, configuring, and/or using the user input system 140. In some embodiments, the user application 147 includes computer-executable program code portions for instructing the processor 144 to perform one or more of the functions of the user application 147 described and/or contemplated herein. In some embodiments, the user application 147 may include and/or use one or more network and/or system communication protocols.

Also shown in FIG. 1 is the user interface 149. In some embodiments, the user interface 149 includes one or more output devices, such as a display and/or speaker, for presenting information to the user. In some embodiments, the user interface 149 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments, the user interface 149 includes the input and display devices of a mobile device, which are operable to receive and display information.

FIG. 1 also illustrates a system 130, in accordance with an embodiment of the present invention. The system 130 may refer to the “apparatus” described herein. The system 130 may include any computerized apparatus that can be configured to perform any one or more of the functions of the system 130 described and/or contemplated herein. In accordance with some embodiments, for example, the system 130 may include a computer network, an engine, a platform, a server, a database system, a front end system, a back end system, a personal computer system, and/or the like. Therefore, the system 130 may be a server managed by the business. The system 130 may be located at the facility associated with the business or remotely from the facility associated with the business. In some embodiments, such as the one illustrated in FIG. 1, the system 130 includes a communication interface 132, a processor 134, and a memory 136, which includes a system application 137 and a structured database 138 stored therein. As shown, the communication interface 132 is operatively and selectively connected to the processor 134, which is operatively and selectively connected to the memory 136.

It will be understood that the system application 137 may be configured to implement any one or more portions of the various user interfaces and/or process flow described herein. The system application 137 may interact with the user application 147. It will also be understood that, in some embodiments, the memory includes other applications. It will also be understood that, in some embodiments, the system application 137 is configured to communicate with the structured database 138, the user input system 140, or the like.

It will be further understood that, in some embodiments, the system application 137 includes computer-executable program code portions for instructing the processor 134 to perform any one or more of the functions of the system application 137 described and/or contemplated herein. In some embodiments, the system application 137 may include and/or use one or more network and/or system communication protocols.

In addition to the system application 137, the memory 136 also includes the structured database 138. As used herein, the structured database 138 may be one or more distinct and/or remote databases. In some embodiments, the structured database 138 is not located within the system and is instead located remotely from the system. In some embodiments, the structured database 138 stores information or data described herein.

It will be understood that the structured database 138 may include any one or more storage devices, including, but not limited to, datastores, databases, and/or any of the other storage devices typically associated with a computer system. It will also be understood that the structured database 138 may store information in any known way, such as, for example, by using one or more computer codes and/or languages, alphanumeric character strings, data sets, figures, tables, charts, links, documents, and/or the like. Further, in some embodiments, the structured database 138 may include information associated with one or more applications, such as, for example, the system application 137. It will also be understood that, in some embodiments, the structured database 138 provides a substantially real-time representation of the information stored therein, so that, for example, when the processor 134 accesses the structured database 138, the information stored therein is current or substantially current.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

In addition, the various portions of the system environment 100 may be maintained for and/or by the same or separate parties. It will also be understood that the system 130 may include and/or implement any embodiment of the present invention described and/or contemplated herein. For example, in some embodiments, the system 130 is configured to implement any one or more of the embodiments of the process flows described and/or contemplated herein in connection any process flow described herein. Additionally, the system 130 or the user input system 140 is configured to initiate presentation of any of the user interfaces described herein.

Peer-to-peer (P2P) payment services, in the last decade, have emerged to provide users with a multitude of payment choices. For purposes of this invention, P2P payment is defined as a payment made by one user to another user or to an entity. In such cases, the sender of the payment is typically a user. The recipient may either be another user or an entity. In some embodiments, such P2P payments enable the user to create aliases (e.g., mobile numbers, email addresses, social networking identifier, or the like) that are then mapped back to the user's financial institution accounts. In doing so, the user may use the alias in lieu of the financial institution account information to transfer funds. In this way, the user's financial institution information remains secure, and in situations where the user's alias is compromised, the user may simply create another alias instead of going through the hassle of replacing financial institution account information. In recent years, options for how to make a P2P payment has grown. While many users have the option to use the P2P payment service provided by their financial institution, users have also been interested in many alias based third party P2P payment services.

The continued growth of mobile financial information services, funds transfer, bill payment and presentation, account management and customer service solutions has enabled financial institutions to provide users with more efficient, secure, and fast fund transfer options. For example, electronic bill payment is a feature of online, mobile, and telephone banking, which allows a customer of a financial institution to transfer funds from their transaction or credit card account to a creditor or vendor such as public utility to be credited against a specific account. In such cases, the user typically has to access the mobile banking platform associated with the financial institution to execute such actions. However, not all customers have access to robust bill payment services available to them through their financial institution, or they choose not to utilize the available features. In the alternative, the user may have to set up their own direct pay solutions with the vendor (e.g., electric, water, gas, or the like) to whom the customer owes recurring payments.

The present invention provides the functional benefit of leveraging third party P2P payment service for electronic bill payment by allowing the user to choose their preferred third party P2P payment service and define destination end-points to transfer funds. In this way, the present invention enables the user to access proprietary features provided by the financial institution via a preferred third party P2P payment service using specific aliases.

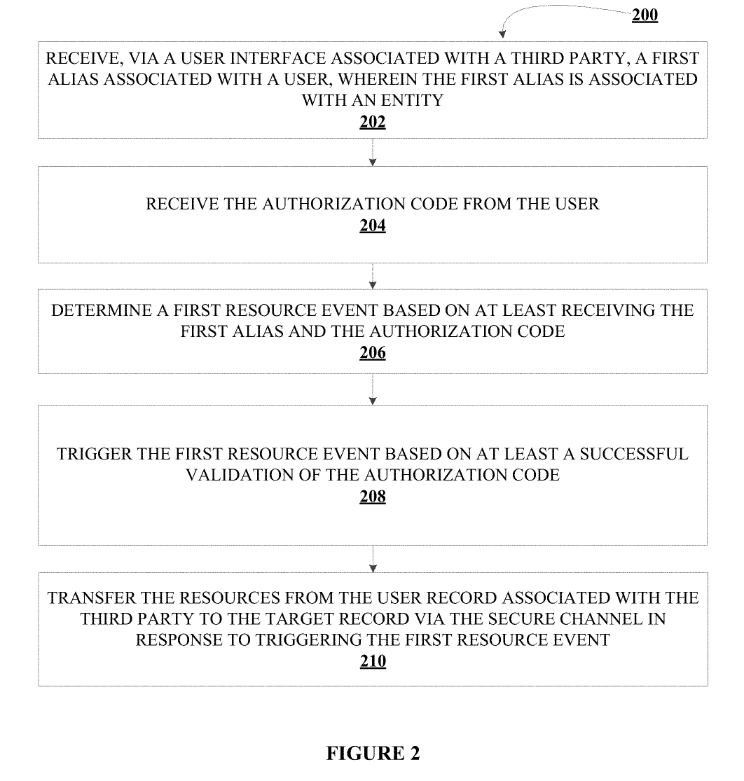

FIG. 2 illustrates a general process flow for transfer of resources via a secure channel using a first alias and an authorization code 200, in accordance with an embodiment of the invention. As shown in block 202, the process flow includes receiving, via a user interface associated with a third party, a first alias associated with a user. In some embodiments, the first alias may be associated with an entity. For example, the first alias may refer to a destination end-point associated with the entity. In one aspect, the destination end-point may be a user record associated with the user and managed by the entity. In another aspect, the destination end-point may trigger the establishing of a secure channel between the entity and the user interface. In yet another aspect, the destination end-point may refer to one or more proprietary features associated with the entity. In this way, the first alias may be used to access the one or more proprietary features. For purposes of the invention, a third party may be a P2P service provider, or any similar service provider capable of facilitating transfer of resources (e.g. funds) from a source to a destination.

In response to receiving the first alias, the system may be configured to dynamically generate on the user interface associated with the third party, a web portal associated with the entity. In some embodiments, the web portal may include a control element capable of enabling the user to input an authorization code. In one aspect, the authorization code may be used to identify a specific resource event. In some embodiments, the system may be configured to initiate relevant aspects of the specific resource event identified by the first alias on the user interface as an embedded web page. In this regard, the system may be configured to recognize the first alias and initiate the mobile application associated with the entity, which is otherwise inactive. In response to initiating the mobile application, the system may then be configured to retrieve relevant aspects of the resource event associated with the first alias from the mobile application. In response to retrieving the relevant aspects of the resource event, the system may then be configured to dynamically generate an embedded web page comprising the retrieved aspects of the resource event on the user interface associated with the third party.

As shown in block 204, the process flow includes receiving, via the web portal, the authorization code from the user. Next, as shown in block 206, the process flow includes determining a first resource event based on at least receiving the first alias and the authorization code. In some embodiments, the first resource event may include the transfer of resources from a user record associated with the third party to a target record, via a secure channel associated with the entity. In this regard, the system may be configured to identify the target record, establish a secure channel between the user record associated with the third party and the target record, and initiate the transfer of records between the user record associated with the third party and the target record via the secure channel. In some embodiments, the user record may include one or more deposit accounts associated with the user that are linked to the third party P2P payment service. In one aspect, the deposit account may be associated with the entity. For example, the deposit account may be a checking account, savings account, or the like, associated with the entity that the user has linked to his/her third party P2P payment service. In some embodiments, the system may be configured to enable the user to initiate the transfer of resources from the deposit account to the target record via the third party P2P. While this resource event may be initiated by the user via the mobile application associated with the entity itself, the user may be required to specifically sign up for the resource event with the entity. By initiating the resource event via the third party P2P payment service, the system may be configured to now enable the user to circumvent the additional step of signing up for the resource event and instead use the third party P2P payment service to initiate the resource event directly. In another example, the deposit account may be a checking account, savings account, or the like, associated with an entity different from the entity associated with the resource event. In this example, the user may access a resource event provided by the entity, which may not be available to the user via the entity in which the user has a deposit account.

Next, as shown in block 208, the process flow includes triggering the first resource event based on at least the successful validation of the authorization code. In this regard, the authorization code is compared to a pre-existing authorization code table associated with one or more resource events associated with the entity to determine a match. In response to determining a match, the system may be configured to trigger the first resource event. In some embodiments when only a partial match is determined, the system may be configured to generate and display on the web portal, a list of resource events with partial matches to the authorization code. In this way, the system may be configured to allow the user to select a particular resource event that the user wishes to execute.

Next, in response to triggering the first resource event, the process flow includes transferring the resources from the user record associated with the third party to the target record via the secure channel, as shown in block 210.

By way of example, the first alias may refer to bill pay services provided by the entity. The authorization code may be used to indicate the type of bill. Typically, to use the bill pay service provided by the entity, the user typically initiates a mobile application associated with the entity on the user device and begins executing the bill pay option by selecting the bill provider, providing account information for each bill, provide authorization to the entity to transfer funds on your behalf. In these cases, the user is typically required to enroll in the bill pay service prior to being able to access the feature. In contrast, in the present invention, the user does not have to access the mobile application associated with the entity to access the bill pay service. The user may access the bill pay service provided by the entity by entering the first alias via the user interface associated with the third party P2P payment service, and select a particular bill by entering the authorization code. In doing so, the system may then trigger the transfer of funds from the deposit account linked to the third party P2P payment service towards the identified bill.

In some embodiments, the system may be configured to leverage third party P2P payment service to route funds into one or more liability accounts by defining destination end-points using aliases. In this regard, the system may be configured to generate an alias based on a user's preferred third party P2P payment service and define destination end-points to transfer funds.

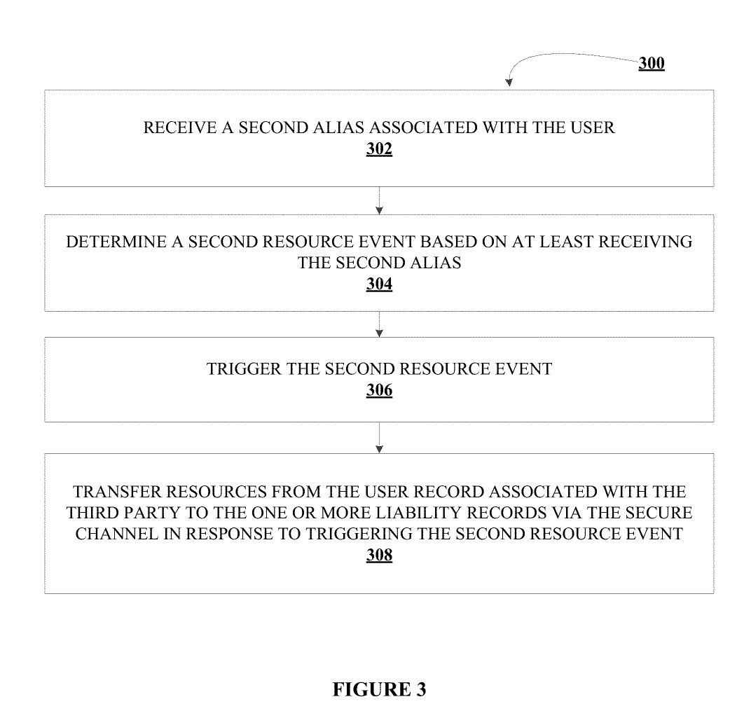

FIG. 3 illustrates a general process flow for transfer of resources via a secure channel using a second alias, in accordance with an embodiment of the invention. As shown in block 302, the process flow includes receiving, via the user interface associated with the third party, a second alias associated with the user. In some embodiments, the second alias comprises identification information associated with one or more user liability records. As used herein, a “liability record” may refer to a general ledger account in which a user and/or entity may record debt, obligations, deposits and pre-payments, certain deferred income taxes, etc. that are the result of a past transaction.

Next, as shown in block 304, the process flow includes determining a second resource event based on at least receiving the second alias. In this regard, the resources are transferred from the user record associated with the third party to the one or more liability records via the secure channel. In some embodiments, the system may be configured to provide the user with one or more aliases and map the one or more aliases with each of the user's one or more liability records. In this regard, the system may be configured to generate one or more aliases for each liability record based on the user's third party P2P service provider. Each third party P2P service provider may have a specific format associated with an alias. In one aspect, the system may be configured to receive from the user, information associated with one or more preferred third party P2P service providers the user is currently using, or wishes to use. In addition, the system may also receive information associated with one or more liability records associated with the user. In response, the system may be configured to dynamically generate one or more aliases for the user specific to each third part P2P service provider and liability record. In some embodiments, the system may be configured to enable the user to generate the alias. In doing so, the system may be configure to establish a link between the generated alias and the one or more liability record. In cases where the user wishes to use multiple third party P2P service providers, the system may be configured to establish a link between each aliases generated for the one or more preferred third party P2P service providers and the one or more liability records.

In response to determining the second resource event, the process flow includes triggering the second resource event, as shown in block 306. In some embodiments, the second resource event includes the transfer of resources from one or more user records associated with the third party P2P service provider to the one or more liability records linked to the alias. Accordingly, the system may then be configured to transfer resources from the user record associated with the third party P2P service provider to the one or more liability record via the secure channel in response to triggering the second resource event, as shown in block 308.

By way of example, the second alias may refer directly to one or more recurring payment accounts associated with the user (e.g., mortgage account, credit card account). By establishing an alias, the user's recurring payment accounts may be linked with one or more third party P2P service providers such that when the user initiates a payment to a recurring payment account, the system triggers the payment by accessing a debit account previously linked to the third party P2P service provider and transfers funds from the debit account to the recurring payment account. Such unique payment aliases will facilitate more convenient payments as it will not require users to have to request one time use payment tokens. Further, they facilitate direct payments on credit cards as it goes through various life cycle changes that can alter the account information (e.g., lost information, product upgrades, or the like).

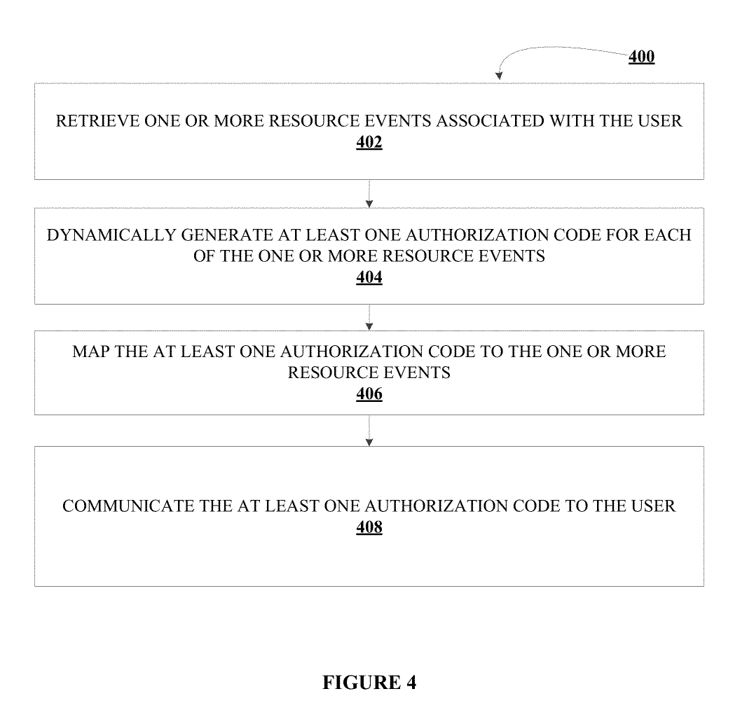

FIG. 4 illustrates a general process flow for mapping a dynamically generated authorization code to a resource events 400, in accordance with an embodiment of the invention. As shown in block 402, the process flow includes retrieving one or more resource events associated with the user. As described herein, the first alias may refer to a service (e.g., bill pay service) provided by the entity that the user wishes to access. To use the service to execute an action effectively, the user must be able to further narrow the actions (i.e., resource events) capable of being performed via the service. In this regard, the system may be configured to dynamically generate at least one authorization code for each of the one or more resource events, as shown in block 404. In doing so, the system may be configured to map the at least one authorization code to the one or more resource events, as shown in block 406. In this way, when the system receives an authorization code from the user, the system may match the authorization code with the one or more resource events and determine which of the one or more resource events to trigger. In response to mapping the authorization code to the resource events, the process flow includes communicating the at least one authorization code to the user, as shown in block 408. In some embodiments, authorization code is communicated to the user via at least an online portal, a contact center, a financial center, a text message, an email, or the like.

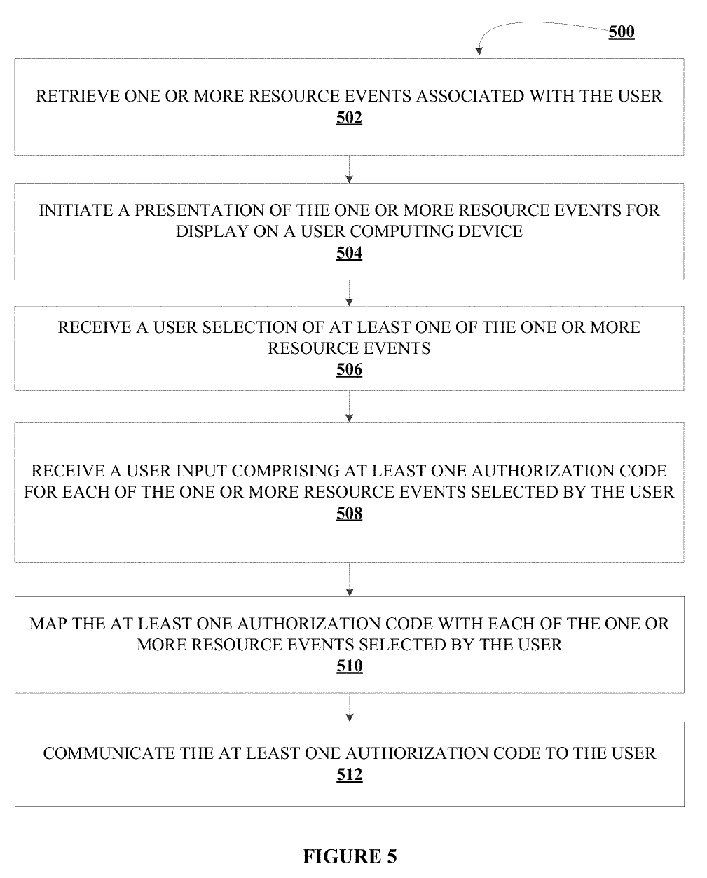

FIG. 5 illustrates a general process flow for mapping a user generated authorization code to a resource events, in accordance with an embodiment of the invention. As shown in block 502, the process flow includes retrieving the one or more resource events associated with the user. In this regard, once the system recognizes that the user wishes to access a particular service provided by the entity based on the first alias, the system may be configured to determine all resource events available to the user and initiate a presentation of a user interface for display on the user device, and provide each of the one or more resource events to the user. In response, the process flow includes receiving a user selection of at least one of the one or more resource events, as shown in block 504. In response to receiving the user selection, the process flow then includes receiving a user input comprising at least one authorization code for each of the one or more resource events selected by the user, as shown in block 506. In this way, the user may determine an authorization code that is convenient to the user.

Next, as shown in block 508, the process flow includes mapping the at least one authorization code received from the user with each of the one or more resource events selected by the user. In this way, when the system receives the authorization code from the user, the corresponding resource event is triggered. In response to mapping the authorization code to the resource events, the process flow includes communicating the at least one authorization code to the user, as shown in block 510.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for transfer of resources via a secure channel using an alias, the system comprising:
at least one non-transitory storage device;
at least one processor; and
at least one module stored in said storage device and comprising instruction code that is executable by the at least one processor and configured to cause said at least one processor to:
electronically receive, via a user interface associated with a third party, a first alias associated with a user, wherein the first alias is associated with an entity;
dynamically generate on the user interface associated with the third party, a web portal associated with the entity, wherein the web portal comprises a control element to enable the user to input an authorization code;
electronically receive, via the web portal, the authorization code from the user;
determine a first resource event based on at least receiving the first alias and the authorization code, wherein the first resource event comprises a transfer of resources, via a secure channel associated with the entity, from a user record associated with the third party to a target record;
trigger the first resource event based on at least a successful validation of the authorization code; and
transfer the resources from the user record associated with the third party to the target record via the secure channel in response to triggering the first resource event.

2. The system of claim 1, wherein the module is further configured to:
electronically receive, via the user interface associated with the third party, a second alias associated with the user, wherein the second alias comprises identification information associated with one or more user liability records;
determine a second resource event based on at least receiving the second alias, wherein the second resource event comprises a transfer of resources, via the secure channel, from the user record associated with the third party to the one or more liability records;
trigger the second resource event; and
transfer resources from the user record associated with the third party to the one or more liability records via the secure channel in response to triggering the second resource event.

3. The system of claim 1, wherein the module is further configured to:
retrieve one or more resource events associated with the user;
dynamically generate at least one authorization code for each of the one or more resource events;
map the at least one authorization code to the one or more resource events; and
communicate the at least one authorization code to the user.

4. The system of claim 3, wherein the at least one authorization code is communicated to the user via at least an online portal, a contact center, a financial center, a text message, and an email.

5. The system of claim 1, wherein the module is further configured to:
retrieve one or more resource events associated with the user;
initiate a presentation of the one or more resource events for display on a user computing device;
receive a user selection of at least one of the one or more resource events;
receive a user input comprising at least one authorization code for each of the one or more resource events selected by the user;
map the at least one authorization code with each of the one or more resource events selected by the user; and
communicate the at least one authorization code to the user.

6. The system of claim 1, wherein the module is further configured to trigger the resource event, wherein triggering further comprises:
identifying the target record;
establishing the secure channel between the user record associated with the third party and the target record; and
initiating, via the secure channel, the transfer of resources between the user record associated with the third party and the target record.

7. The system of claim 1, wherein the third party is an alias-based payment service.

8. The system of claim 1, wherein the module is further configured to determine the target record from a plurality of target records based on at least the authorization code.

9. A computerized method for transfer of resources via a secure channel using an alias, the method comprising:
electronically receiving, via a user interface associated with a third party, a first alias associated with a user, wherein the first alias is associated with an entity;
dynamically generating, using a computing device processor, on the user interface associated with the third party, a web portal associated with the entity, wherein the web portal comprises a control element to enable the user to input an authorization code;
electronically receiving, via the web portal, the authorization code from the user;
determining, using a computing device processor, a first resource event based on at least receiving the first alias and the authorization code, wherein the first resource event comprises a transfer of resources, via a secure channel associated with the entity, from a user record associated with the third party to a target record;
triggering, using a computing device processor, the first resource event based on at least a successful validation of the authorization code; and
transferring, using a computing device processor, the resources from the user record associated with the third party to the target record via the secure channel in response to triggering the first resource event.

10. The method of claim 9, wherein the method further comprises:
electronically receiving, via the user interface associated with the third party, a second alias associated with the user, wherein the second alias comprises identification information associated with one or more user liability records;
determining a second resource event based on at least receiving the second alias, wherein the second resource event comprises a transfer of resources, via the secure channel, from the user record associated with the third party to the one or more liability records;
triggering the second resource event; and
transferring resources from the user record associated with the third party to the one or more liability records via the secure channel in response to triggering the second resource event.

11. The method of claim 9, wherein the method further comprises:
retrieving one or more resource events associated with the user;
dynamically generating at least one authorization code for each of the one or more resource events;
mapping the at least one authorization code to the one or more resource events; and
communicating the at least one authorization code to the user.

12. The method of claim 11, wherein the at least one authorization code is communicated to the user via at least an online portal, a contact center, a financial center, a text message, and an email.

13. The method of claim 9, wherein the method further comprises:
retrieving one or more resource events associated with the user;
initiating a presentation of the one or more resource events for display on a user computing device;
receiving a user selection of at least one of the one or more resource events;
receiving a user input comprising at least one authorization code for each of the one or more resource events selected by the user;
mapping the at least one authorization code with each of the one or more resource events selected by the user; and
communicating the at least one authorization code to the user.

14. The method of claim 9, wherein triggering further comprises:
identifying the target record;
establishing the secure channel between the user record associated with the third party and the target record; and
initiating, via the secure channel, the transfer of resources between the user record associated with the third party and the target record.

15. A computer program product for transfer of resources via a secure channel using an alias, the computer program product comprising a non-transitory computer-readable medium comprising code causing a first apparatus to:
electronically receive, via a user interface associated with a third party, a first alias associated with a user, wherein the first alias is associated with an entity;
dynamically generate on the user interface associated with the third party, a web portal associated with the entity, wherein the web portal comprises a control element to enable the user to input an authorization code;
electronically receive, via the web portal, the authorization code from the user;
determine a first resource event based on at least receiving the first alias and the authorization code, wherein the first resource event comprises a transfer of resources, via a secure channel associated with the entity, from a user record associated with the third party to a target record;
trigger the first resource event based on at least a successful validation of the authorization code; and
transfer the resources from the user record associated with the third party to the target record via the secure channel in response to triggering the first resource event.

16. The computer program product of claim 15, wherein the first apparatus is further configured to:
electronically receive, via the user interface associated with the third party, a second alias associated with the user, wherein the second alias comprises identification information associated with one or more user liability records;
determine a second resource event based on at least receiving the second alias, wherein the second resource event comprises a transfer of resources, via the secure channel, from the user record associated with the third party to the one or more liability records;
trigger the second resource event; and
transfer resources from the user record associated with the third party to the one or more liability records via the secure channel in response to triggering the second resource event.

17. The computer program product of claim 15, wherein the first apparatus is further configured to:
retrieve one or more resource events associated with the user;
dynamically generate at least one authorization code for each of the one or more resource events;
map the at least one authorization code to the one or more resource events; and
communicate the at least one authorization code to the user.

18. The computer program product of claim 17, wherein the at least one authorization code is communicated to the user via at least an online portal, a contact center, a financial center, a text message, and an email.

19. The computer program product of claim 15, wherein the module is further configured to:
retrieve one or more resource events associated with the user;
initiate a presentation of the one or more resource events for display on a user computing device;
receive a user selection of at least one of the one or more resource events;
receive a user input comprising at least one authorization code for each of the one or more resource events selected by the user;
map the at least one authorization code with each of the one or more resource events selected by the user; and
communicate the at least one authorization code to the user.

20. The computer program product of claim 15, wherein the first apparatus is further configured to trigger the resource event, wherein triggering further comprises:
identifying the target record;
establishing the secure channel between the user record associated with the third party and the target record; and
initiating, via the secure channel, the transfer of resources between the user record associated with the third party and the target record.
